(19) United States
(12) Patent Application Publication
(10) Pub. No.: US 2008/0114737 A1
(43) Pub. Date: May 15, 2008

(54) METHOD AND SYSTEM FOR AUTOMATICALLY IDENTIFYING USERS TO PARTICIPATE IN AN ELECTRONIC CONVERSATION

(76) Inventors: Daniel Neely, Madison, WI (US); Glenn Jenkins, Madison, WI (US); Michael Mitchell, Santa Cruz, CA (US); Matthew Wulff, Brooklyn, WI (US); Rhonda Saylor, Mount Horeb, WI (US)

Correspondence Address: FOLEY & LARDNER LLP, 150 EAST GILMAN STREET, P.O. BOX 1497, MADISON, WI, 53701-1497, US

(21) Appl. No.: 11/937,682

(22) Filed: Nov. 9, 2007

Related U.S. Application Data
(60) Provisional application No. 60/865,721, filed on Nov. 14, 2006.

(51) Int. Cl. G06F 7/06; G06F 15/16; G06F 17/30; G06F 12/00

(52) U.S. Cl. 707/3; 709/202; 707/10; 707/E17.009; 707/E17.014

(57) ABSTRACT

A device and a method of automatically identifying users for an electronic conversation is provided. A user interaction indicator is received at a first computer system from a second computer system. The user interaction indicator indicates an interaction by a user at the second computer system with a website. A determination is made concerning whether to initiate an electronic conversation with the user at the second computer system based on predefined criteria and the received user interaction indicator. If a determination to initiate the electronic conversation is made, the electronic conversation with the user at the second computer system is initiated. The electronic conversation may be initiated with a second user of the website, with an agent and/or with a social network. The agent is a computer generated entity. The social network may be associated with users of the website.

### CROSS-REFERENCE TO RELATED APPLICATIONS

This application claims the benefit under 35 U.S.C. § 119(e) of U.S. Provisional Patent Application Ser. No. 60/865,721 that was filed Nov. 14, 2006, the disclosure of which is incorporated by reference in its entirety.

### FIELD

The field of the disclosure relates generally to social networks in a computer networked environment. More specifically, the disclosure relates to a method and a system for automatically identifying a user for participation in an electronic conversation and/or in a social network.

### BACKGROUND

Social networks include a variety of members who join to meet people, to discuss common issues, to locate information, etc. A social networking platform may include social networking features such as identity, presence, relationships, profiles, groups, conversations, and sharing. In general, a member of a social network has a profile that identifies characteristics of the member for other members of the network and for the social networking platform. The social network can facilitate interaction between members based on associations or relationships identified from the member profiles. A social network may include a plurality of sub-networks and groups that further characterize members. For example, a social network may be associated with a health care organization, a sub-network of the social network may be associated with cancer, and a group of the sub-network may be associated with lung cancer. Social networks may be accessed through a portal, a general website, a phone or a personal digital assistant, etc.

In the commercial sector, on-line merchants have created groups of customers who share common interests in the goods and services offered by the on-line merchant. Some merchants include systems that provide suggestions to their customers based on determined needs of the customer. In such commercial, social networks, customers interact with the merchant, but generally do not interact directly with each other. Additionally, current customer and business intelligence solutions provide information on what the customer is buying based on the interactions with the merchant. This purchasing data, however, only represents a purchase decision at a point in time and does not indicate why the customer selected a product for purchase; what resources were used to inform the buying decision; what the customer's objectives were in making the purchase; what will cause the customer to repeat their transaction; or what will cause other customers to purchase the product. Thus, what is needed is a system and a method that support a conversation between a merchant and/or other members of a social network/sub-network/group so that an understanding of these processes can be obtained.

### SUMMARY

Exemplary embodiments provide a method and a system for identifying users to participate in an electronic conversation. In other exemplary embodiments, a method and a system for facilitating the electronic conversation among the users is provided. In still other exemplary embodiments, users for inclusion in a social network/sub-network/group are identified. In yet other exemplary embodiments, a method and a system for analyzing the conversation between the users and/or the other members of the social network/sub-network/group is provided.

An exemplary method of automatically identifying users for an electronic conversation is provided. A user interaction indicator is received at a first computer system from a second computer system. The user interaction indicator indicates an interaction by a user at the second computer system with a website. A determination is made concerning whether to initiate an electronic conversation with the user at the second computer system based on predefined criteria and the received user interaction indicator. If a determination to initiate the electronic conversation is made, the electronic conversation with the user at the second computer system is initiated. The electronic conversation may be initiated with a second user of the website, with an agent, and/or with a social network. The agent is a computer generated entity.

In another exemplary embodiment, a computer-readable medium is provided comprising computer-readable instructions that, upon execution by a processor, cause a computing device to automatically identify users for an electronic conversation.

In yet another exemplary embodiment, a device is provided. The device includes, but is not limited to, a processor, a communication interface, and the computer-readable medium. The communication interface operably couples to the processor to receive a user interaction indicator from a computer system using a network. The computer-readable medium operably couples to the processor. The computer-readable medium comprises instructions that, upon execution by the processor, perform the operations of the method of automatically identifying users for an electronic conversation.

Other principal features and advantages of the invention will become apparent to those skilled in the art upon review of the following drawings, the detailed description, and the appended claims.

### BRIEF DESCRIPTION OF THE DRAWINGS

Exemplary embodiments of the invention will hereafter be described with reference to the accompanying drawings, wherein like numerals denote like elements.

FIG. 1 depicts a system that includes devices supporting an electronic conversation in accordance with an exemplary embodiment.

FIG. 2 is a block diagram of a first device supporting the electronic conversation in accordance with an exemplary embodiment.

FIG. 3 is a block diagram of a second device in communication with the first device to support the electronic conversation at the first device of FIG. 2 in accordance with an exemplary embodiment.

FIGS. 4a-4c are flow diagrams illustrating exemplary operations performed by a conversation facilitator application in accordance with an exemplary embodiment.

FIG. 5 depicts a user interface of an electronic conversation system in accordance with an exemplary embodiment.

FIG. 6 depicts a menu of the user interface of FIG. 5 in accordance with an exemplary embodiment.

FIG. 7 depicts a user interface of a social network application in accordance with an exemplary embodiment.

FIG. 8 depicts a user interface of an interaction processing and reporting application in accordance with an exemplary embodiment.

FIG. 9 depicts a second user interface of the electronic conversation system of FIG. 5 in accordance with a second exemplary embodiment.

FIG. 10 depicts a conversation between a user and an agent using the second user interface of FIG. 9 in accordance with an exemplary embodiment.

FIG. 11 depicts a “View Top 10” capability provided using the second user interface of FIG. 9 in accordance with an exemplary embodiment.

### DETAILED DESCRIPTION

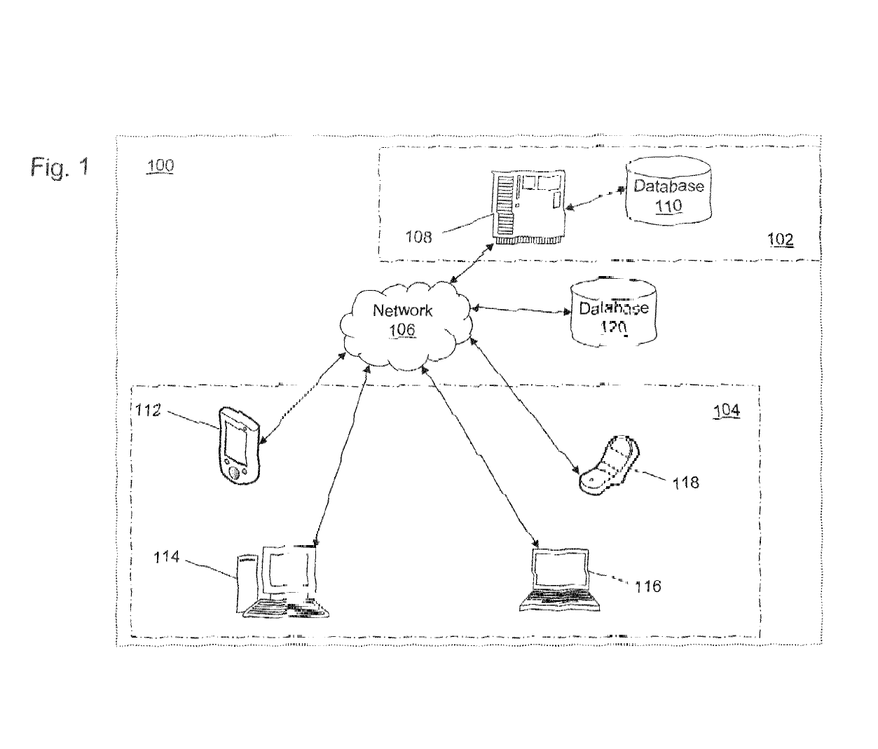

With reference to FIG. 1, a system diagram of an electronic conversation system 100 is shown in accordance with an exemplary embodiment. Electronic conversation system 100 may include a server system 102, a plurality of user devices 104, and a network 106. There may be fewer or additional networks in electronic conversation system 100. For example, network 106 may include one or more local area network, one or more wide area network, one or more cellular network, etc. In an exemplary embodiment, network 106 includes the Internet.

Server system 102 may include a server 108 and a database 110. Server system 102 may include a plurality of servers. Server 108 includes or can access database 110 either through a direct connection or through a second network. The second network may include or otherwise use network 106. Database 110 may include a plurality of databases that may be organized into multiple database tiers to improve data management and access. Database 110 is a data repository for electronic conversation system 100. Database 110 may utilize various database technologies and a variety of different formats as known to those skilled in the art including a simple file system, a relational database, a system of tables, etc. alone or in combination.

In electronic conversation system 100, the plurality of user devices 104 send and receive signals through network 106 to/from server 108 and/or to/from other user devices. Electronic conversation system 100 can include any number and type of user devices that may be organized into subnets. The plurality of client devices 104 may include a first user device 112, a second user device 114, a third user device 116, and a fourth user device 118. The plurality of user devices 104 may include computing devices of any form factor such as a laptop, a desktop, an integrated messaging device, a personal digital assistant, a cellular telephone, an IPod, etc. Electronic conversation system 100 may include additional types of devices. The plurality of user devices 104 communicate using various transmission media that may be wired or wireless.

Server 108 includes or can access database 120 either through a direct connection, a second network, and/or through network 106. Database 120 may include a plurality of databases that may be organized into multiple database tiers to improve data management and access. Database 120 is a data repository for an on-line merchant which may include user profile data associated with a social network application. Database 120 may utilize various database technologies and a variety of different formats as known to those skilled in the art including a simple file system, a relational database, a system of tables, etc. alone or in combination.

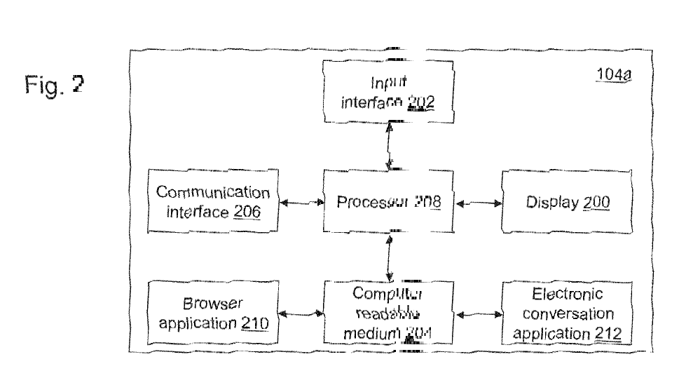

With reference to FIG. 2, a user device 104a is shown in an exemplary embodiment. User device 104a may include a display 200, an input interface 202, a computer-readable medium 204, a communication interface 206, a processor 208, a browser application 210, and an electronic conversation application 212. Different and additional components may be incorporated into user device 104a.

Display 200 presents information to a user of user device 104a. For example, display 200 may be a thin film transistor display, a light emitting diode display, a liquid crystal display, or any of a variety of different displays known to those skilled in the art.

Input interface 202 provides an interface for receiving information from the user for entry into user device 104a as known to those skilled in the art. Input interface 202 may use various input technologies including, but not limited to, a keyboard, a pen and touch screen, a mouse, a track ball, a touch screen, a keypad, one or more buttons, voice-to-text recognition system, etc. to allow the user to enter information into user device 104a or to make selections presented in a user interface displayed on display 200. Input interface 202 may provide both an input and an output interface. For example, a touch screen both allows user input and presents output to the user. User device 104a may include one or more input interfaces that use the same or different input technologies.

Computer-readable medium 204 is an electronic holding place for information so that the information can be accessed by processor 208 as known to those skilled in the art. User device 104a may have one or more computer-readable media that use the same or a different computer-readable medium technology. Computer-readable medium technologies include, but are not limited to, any type of random access computer-readable medium (RAM), any type of read only computer-readable medium (ROM), any type of flash computer-readable medium, etc. User device 104a also may have one or more drives that support the loading of a computer-readable medium such as a compact disc (CD) or digital versatile disc (DVD) or ports that support connectivity with computer-readable media such as flash drives.

Communication interface 206 provides an interface for receiving and transmitting messages, files, and any other information communicable between devices using various protocols, transmission technologies, and media as known to those skilled in the art. Communication interface 206 may support communication using various transmission media that may be wired or wireless. User device 104a may have one or more communication interfaces that use the same or different protocols, transmission technologies, and media.

Processor 208 executes instructions as known to those skilled in the art. The instructions may be carried out by a special purpose computer, logic circuits, or hardware circuits. Thus, processor 208 may be implemented in hardware, firmware, software, or any combination of these methods. The term “execution” is the process of running an application or the carrying out of the operation called for by an instruction. The instructions may be written using one or more programming language, scripting language, assembly language, etc. Processor 208 executes an instruction meaning that it performs the operations called for by that instruction. Processor 208 operably couples with display 200, with input interface 202, with computer-readable medium 204, and with communication interface 206 to receive, to send, and to process information. Processor 208 may retrieve a set of instructions from a permanent computer-readable medium device and copy the instructions in an executable form to a temporary computer-readable medium device that is generally some form of RAM. User device 104a may include a plurality of processors that use the same or a different processing technology.

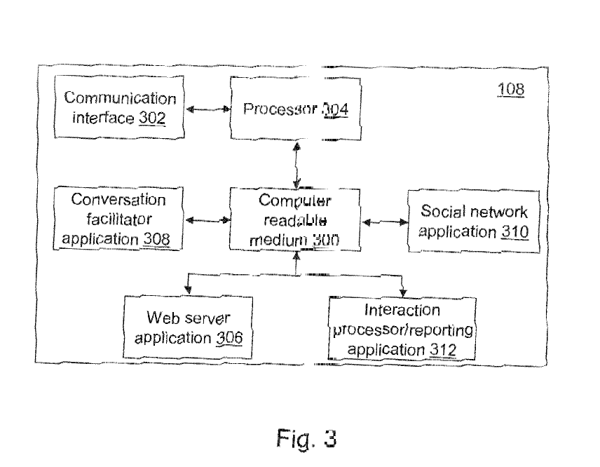

A user may execute browser application 210 installed at user device 104a to access a web server application 306, for example, hosted at server 108 depicted in FIG. 3. For example, the user may enter a uniform resource locator (URL) into browser application 210 where the URL is associated with a resource supported by web server application 306. Through interaction with web server application 306, the user may download and install electronic conversation application 212 at user device 104a. In another exemplary embodiment, electronic conversation application 212 may be embedded within browser application 210 using an interactive web technology such as asynchronous JavaScript™ and the extensible mark-up language (XML). Web server application 306 may control the display of multiple web pages that present information to the user and from which the user may make selections. A web page may contain links to other web pages with related or additional information. Each web page is identified by a URL that includes the location or address of the computer that contains the resource to be accessed in addition to the location of the resource on that computer. The type of file or resource depends on the Internet application protocol. For example, the Hypertext Transfer Protocol (HTTP) may describe a web page to be presented using browser application 210.

Electronic conversation application 212 performs operations associated with electronic conversation processes. The operations may be implemented using hardware, firmware, software, or any combination of these methods. With reference to the exemplary embodiment of FIG. 2, electronic conversation application 212 is implemented in software stored in computer-readable medium 204 and accessible by processor 208 for execution of the instructions that embody the operations of electronic conversation application 212. Electronic conversation application 212 may be written using one or more programming languages, assembly languages, scripting languages, etc. Electronic conversation application 212 may include capabilities associated with a variety of text messaging applications, including, but not limited to, an instant messaging application, a chat session application, an e-mail application, a short messaging service application, a multimedia messaging service application, etc. In an exemplary embodiment, the operations of electronic conversation application 212 are embodied in browser application 210. Electronic conversation application 212 may further provide voice to text and/or text to voice capabilities.

With reference to FIG. 3, components of server 108 are shown in an exemplary embodiment. Server 108 may include a computer-readable medium 300, a communication interface 302, a processor 304, web server application 306, a conversation facilitator application 308, a social network application 310, and an interaction processing/reporting application 312. Different and additional components may be incorporated into server 108. For example, analysis plug-in connections to interaction processing/reporting application 312 and/or to a company's enterprise data analysis/visualization applications may be provided by server 108.

Computer-readable medium 300 is an electronic holding place for information so that the information can be accessed by processor 304 as known to those skilled in the art. Server 108 may have one or more computer-readable media that use the same or a different computer-readable medium technology. Computer-readable medium technologies include, but are not limited to, any type of RAM, any type of ROM, any type of flash computer-readable medium, any type of long term computer-readable medium storage, etc. Server 108 also may have one or more drives that support the loading of a computer-readable medium such as a CD or DVD or ports that support connectivity with computer-readable media such as flash drives.

Communication interface 302 provides an interface for receiving and transmitting messages, files, and any other information communicable between devices using various protocols, transmission technologies, and media as known to those skilled in the art. Communication interface 302 may support communication using various transmission media that may be wired or wireless. Server 108 may have one or more communication interfaces that use the same or different protocols transmission technologies, and media.

Processor 304 executes instructions as known to those skilled in the art. The instructions may be carried out by a special purpose computer, logic circuits, or hardware circuits. Thus, processor 304 may be implemented in hardware, firmware, software or any combination of these methods. The instructions may be written using one or more programming language, scripting language, assembly language, etc. Processor 304 executes an instruction, meaning that it performs the operations called for by that instruction. Processor 304 operably couples with computer-readable medium 300 and with communication interface 302 to receive, to send, and to process information. Processor 304 may retrieve a set of instructions from a permanent computer-readable medium device and copy the instructions in an executable form to a temporary computer-readable medium device that is generally some form of RAM. Server 108 may include a plurality of processors that use the same or a different processing technology.

Conversation facilitator application 308 performs operations associated with automatically identifying users to participate in an electronic conversation over a network and with implementing an agent. The identified users may be anonymous to each other. The operations may be implemented using hardware, firmware, software, or any combination of these methods. With reference to the exemplary embodiment of FIG. 3, conversation facilitator application 308 is implemented in software stored in computer-readable medium 300 and accessible by processor 304 for execution of the instructions that embody the operations of conversation facilitator application 308. Conversation facilitator application 308 may be written using one or more programming languages, assembly languages, scripting languages, etc.

Social network application 310 performs operations associated with a social network. The operations may be implemented using hardware, firmware, software, or any combination of these methods. With reference to the exemplary embodiment of FIG. 3, social network application 310 is implemented in software stored in computer-readable medium 300 and accessible by processor 304 for execution of the instructions that embody the operations of social network application 310. Social network application 310 may be written using one or more programming languages, assembly languages, scripting languages, etc.

Interaction processing/reporting application 312 performs operations associated with analyzing the conversations or discussions between the members of the social network. The operations may be implemented using hardware, firmware, software, or any combination of these methods. With reference to the exemplary embodiment of FIG. 3, interaction processing/reporting application 312 is implemented in software stored in computer-readable medium 300 and accessible by processor 304 for execution of the instructions that embody the operations of interaction processing/reporting application 312. Interaction processing/reporting application 312 may be written using one or more programming languages, assembly languages, scripting languages, etc. In an exemplary embodiment, the operations of one or more of conversation facilitator application 308, of social network application 310, and of interaction processing/reporting application 312 are embodied in or under control of web server application 306. Web server application 306, conversation facilitator application 308, social network application 310, and/or interaction processing/reporting application 312 may be implemented in a single executable or application or may be distributed among modules that differ in number and distribution of functionality from those described herein.

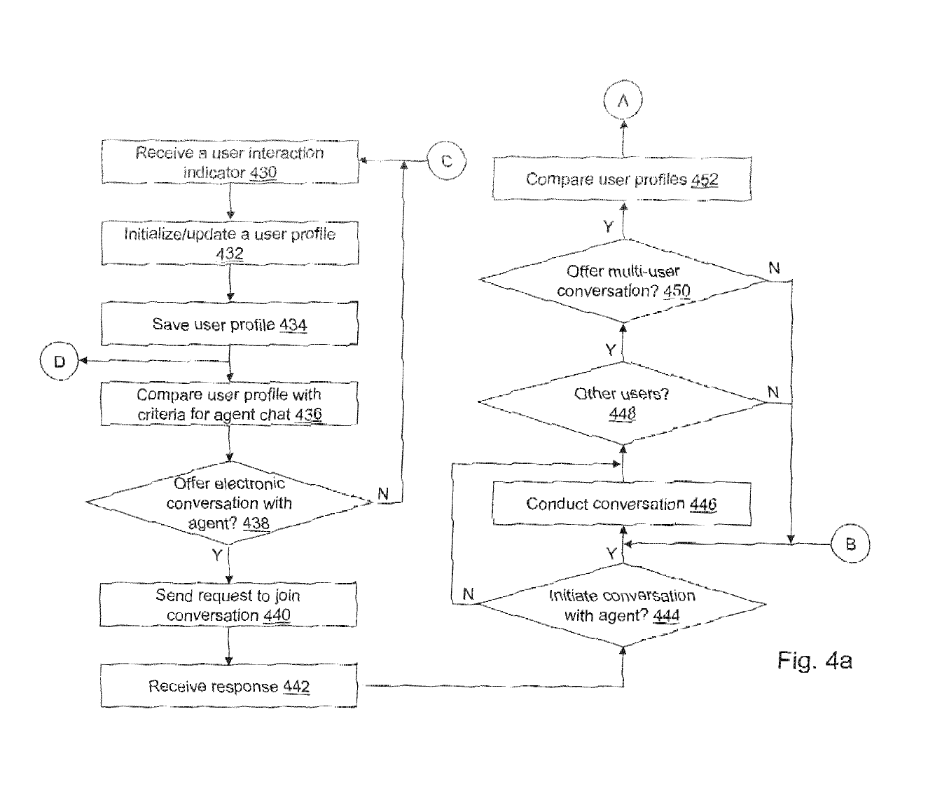

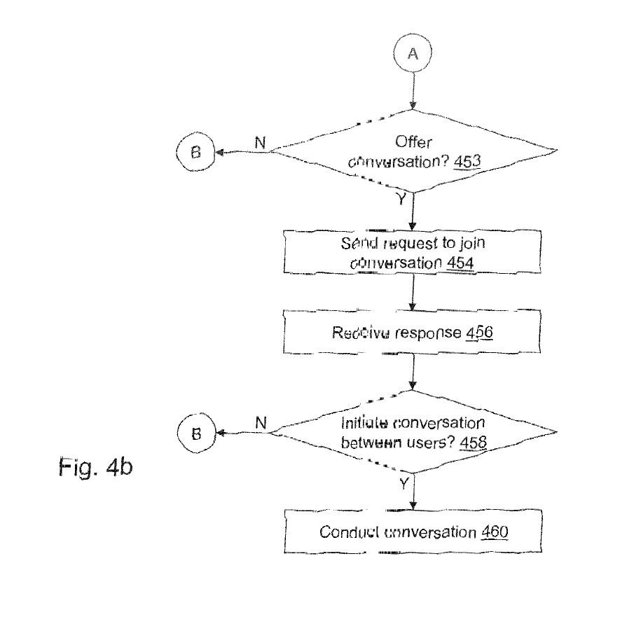

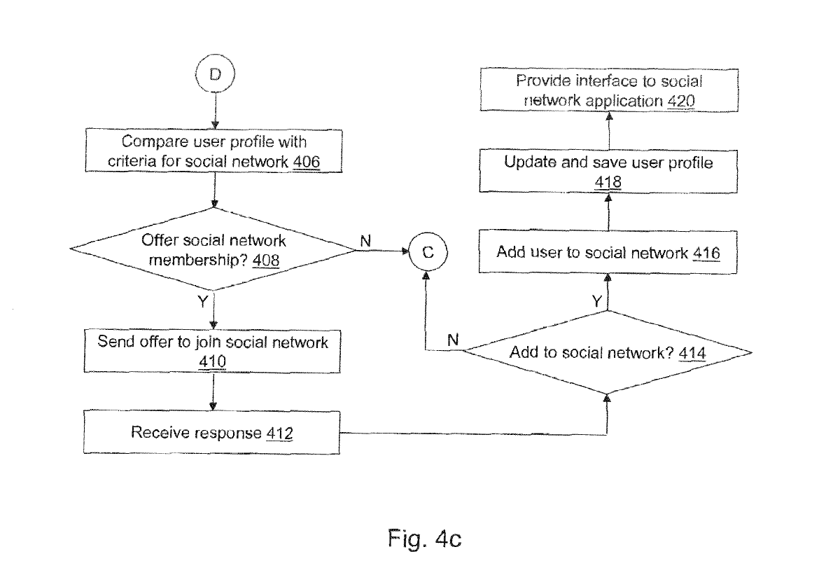

With reference to FIGS. 4a-4c, exemplary operations associated with conversation facilitator application 308 are described. Additional, fewer, or different operations may be performed, depending on the embodiment. The order of presentation of the operations is not intended to be limiting. In an operation 430, a user interaction indicator is received at server 108 from user device 104a. For example, a user at user device 104a may be using a treatment cost estimator presented on display 200 using browser application 210 after accessing a website “MyHealth.com” hosted by web server application 306. Two general categories of users include individuals accessing the website that are employees of the company associated with the website and those that are not employees of the company associated with the website. Options presented each category of user may differ.

In an exemplary embodiment, browser application 210 responds to operations of web server application 306 to cause presentation of information to a user of user device 104a such as the treatment cost estimator. The user interaction indicator may include a variety of informational entities that can be captured relative to the user interaction with web server application 306 using browser application 210. For example, various data elements available from the user's interaction with a website include, but are not limited to, a search term entry, a data entry, a click stream, a URL selection, a website entry point, a website access time, Internet service provider, a login name, an exit point, and a cookie. Thus, the user interaction indicator may indicate that the user is using the cost treatment indicator and may include data associated with the cost treatment indicator. A treatment cost estimator is provided merely as an example interaction with a website that can be captured and/or identified. Any type of interaction with a website can be captured and utilized by web server application 306.

In an operation 432, a user profile is initialized and/or updated based on receipt of the user interaction indicator. In an exemplary embodiment, as the user navigates the website, the user is logged into conversation facilitator application 308 using a background process. For example, conversation facilitator application 308 may include a chat server implemented using an extensible messaging and presence protocol (XMPP) such as Openfire, created by Jive Software. The chat client may be implemented using a Javascript jabber client as part of functionality supported by conversation facilitator application 308 and implemented by electronic conversation application 212. An agent also may be logged into the conversation facilitator application 308 such as the chat server. The agent is a computer generated entity that may be implemented using a mark-up language such as an artificial intelligence mark-up language, XML, etc. In an exemplary embodiment, the agent is implemented as a Java program which includes instructions to interact with users using XMPP.

A series of user identifiers (IDs) may be pre-defined and stored, for example, in database 110 or database 120 or may be created randomly or dynamically based on information associated with the user. In an exemplary embodiment, when a user enters the website, the agent queries session data to determine which user IDs are in use, assigns an available user ID to the session, and logs the user into conversation facilitator application 308 using the assigned user ID. The agent monitors and tracks the uses interaction with the enabled website during their session by accessing and storing keywords associated with each enabled web page the user visits.

In an operation 434, the user profile information, which includes the keywords and the assigned user ID, may be stored, for example, in database 110 or database 120, accessible by conversation facilitator application 308. Keywords can be read or identified from the website using a variety of mechanisms. For example, keywords can be read from <meta> tags placed on each web page. In an exemplary embodiment, <meta> data with a predefined label may be associated with a web page and used to identify keywords. As another example, keywords can be read from the URL of each web page. Keywords also may be dynamically selectable from the text presented in the web page.

A field of the user profile may include the received user interaction indicator. In an exemplary embodiment, the website may require entry of a user login name and/or a password to access certain functionality of the website. The user profile may be associated with the login name and may be populated prior to the user's access of the website. The user profile may include a variety of data associated with characteristics of the user. Exemplary user profile items may include, but are not limited to:

Unique Identifier - alphanumeric locator that allows the system to identify
data from individuals
First name
Last name
Middle initial
Chosen name
Income level
Hobbies
Top world concerns: global, local, personal
Favorite Websites
Trusted sources - personal, family, medical, financial, career
Marital status
Birthday
Company segment (segment identifier for user according to company
assessment)
Company segment data items
(criteria used to define segment for company)
Social network segment (segment identifier for user according to social
network assessment)
Social network segment data items (criteria used to define segment for
social network)
Ethnicity
Religion
Humor type
Health concerns
Risk profile
Favorite brands - personal, family
Email address
Contact preferences by topic
Hometown
City currently living in
Zip code
Sexual orientation
Political view
Interested in - advisors, friends, networking, education, read only,
contribute and read, contribute only, etc.
Languages interested in
Languages spoken
Areas seeking to gain knowledge - personal, career, family
Fashion
Life events (births, deaths, marriages, medical diagnosis, etc.)
Smoking
Drinking
Pets
Living situation
Web page
Free form text
Journals
Groups/communities inside solution to which the user belongs
Groups/communities outside solution to which the user belongs
Picture to represent user
Passions
Sports
Activities
Books
Interesting facts
Share preferences
Occupation
Previous roles
Resume
Music
TV shows
Movies
Cuisines
IM user name
Jangle ID phone number
Address
Country
Photo
Wishlist - personal, family, local, global
Education
High school
College or university
Major
Degree
Year
Industry
Sub-industry
Company/Organization
Company web page
Title
Job description
Work - E-mail, phone
Career skills
Career interests
User headline for me (tag line defined by user to represent them to others)
First thing to know about me
Height
Weight
Eye color
Sign of the zodiac
Hair color
Sites I use regularly for commerce
Sites I use as source information
Topics I am currently interested in
Body art
Looks
1-10 rating on my appearance
Best physical asset
Least favorite body part
Turn ons
Turn offs
Best experience in my life thus far
What I am experiencing right now
Children
Things I would like to change
Ranking of things the user would like to change
Things I would like to learn
My list of 100 things I want to do
Things I would like to share
5 things I can't live without personal
5 things I can't live without work
The short term thing I am trying to solve
The long term thing I am trying to solve
Categories of communication I interact with
Categories of communication I only read
User interaction identifiers
My daily newspaper
Community contributor
My family's favorite activities
About my children
About my pets
Purchase history most recent
Service information
Support information
Other info on customers
Other company classifications
Customer status
Marketing preferences
Marketing items received
The thing I am trying to solve today
Top 10 list
My content
My research
Types of people I am trying to reach
Data presentation preferences

In operation 436, the user profile is compared with criteria for inviting the user to have a conversation with the agent. In an operation 438, a determination of whether or not to offer the conversation with the agent is made based on the comparison. In an exemplary embodiment the criteria may include a length of time spent on the website and/or keywords identified during the users interaction with the website. For example, after the user's initial interaction with the website is detected through receipt of the user interaction indicator, a timer may be started. After a predefined time period, a determination may be made to make an offer to the user to participate in a conversation with the agent. An example time period is three minutes though any time period may be used and this example is not intended to be limiting. If the offer of the conversation with the agent is to be offered, processing continues at an operation 440. If the offer of the conversation with the agent is not to be offered, processing continues at operation 430. In operation 440, a request is sent to the user to join the conversation with the agent.

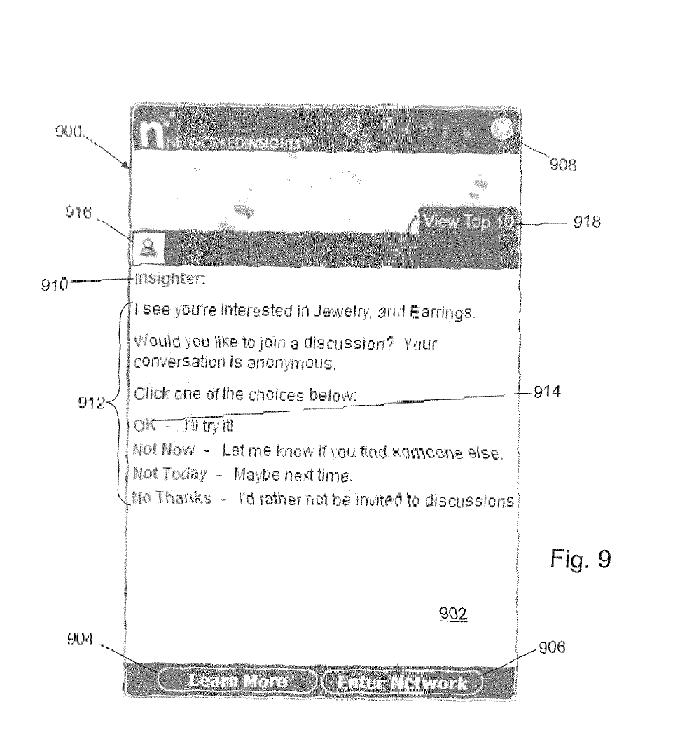

For example, with reference to FIG. 9, a user interface 900 may be presented at user device 104a under control of conversation facilitator application 308 in accordance with an exemplary embodiment. User interface 900 may include a conversation initiation window 902, a “Learn More” button 904, an “Enter Network” button 906, a close button 908, and a “View Top 10” button 918. Conversation initiation window 902 may include a name 910 for the agent and an invitation 912. Name 910 identifies the agent in a subsequent conversation. Invitation 912 invites the user to join in the conversation with the agent. In the exemplary embodiment of FIG. 9, the invitation provides the user with a plurality of response options. For examples the user can select from response options that include a first response option 914 to join the conversation with the agent, a second response option to join a conversation with another user if another user is identified, a third response option to not join the conversation, but to be provided the option to join a conversation in the future, or a fourth response option to not receive any further conversation invitations. The response options may be selectable by the user using a variety of mechanisms as known to those skilled in the art such as selection of a hyperlink, button, menu item, etc. using input interface 202.

In an exemplary embodiment, user selection of “Learn More” button 904 prompts conversation facilitator application 308 to present additional information to the user related to use of electronic conversation application 212. In an exemplary embodiment, user selection of “Enter Network” button 906 prompts conversation facilitator application 308 to present a login page to social network application 310 or to present a welcome page to social network application 310. In an exemplary embodiment, user selection of close button 908 prompts conversation facilitator application 308 to close user interface 900. User interface 900 further may include an agent icon 916 which identifies the agent as participating in the conversation. In an exemplary embodiment, user selection of “View Top 10” button 918 prompts conversation facilitator application 308 to present the top ten most active discussions conducted using social network application 310.

In an operation 442, a response is received from the user. In an operation 444, a determination of whether or not to initiate the conversation with the agent is made based on the received response. If the offer of the conversation with the agent is accepted, processing continues at an operation 446. If the offer of the conversation with the agent is not accepted, processing continues at operation 448.

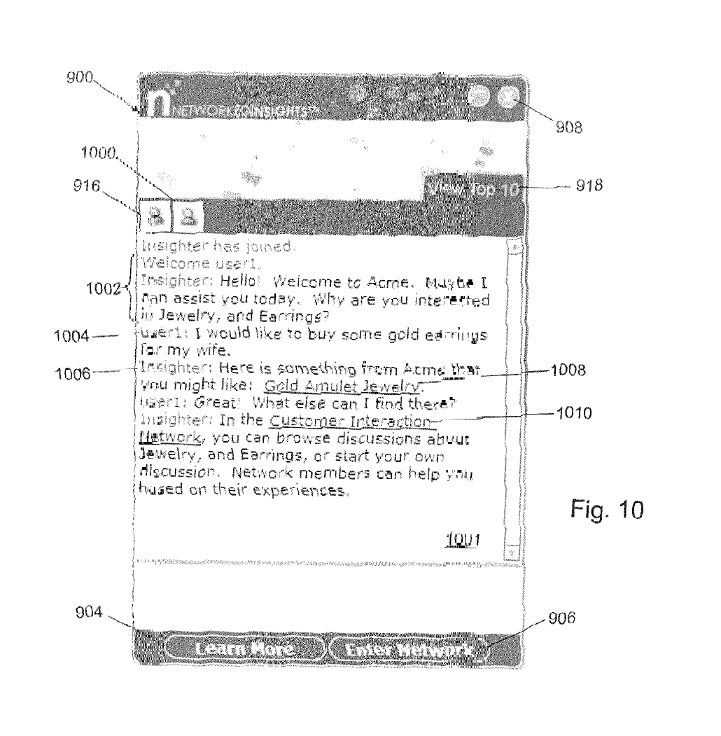

In operation 446, the conversation is initiated and conducted between the user at user device 104a and the agent. The conversation may be presented using browser application 210 or electronic conversation application 212. For example, after user selection of first response option 914, user interface 900, shown with reference to FIG. 10, may be presented to the user at user device 104a under control of conversation facilitator application 308. In the exemplary embodiment of FIG. 10, user interface 900 includes a user icon 1000 which identifies the user as participating in the conversation with the agent and a conversation text window 1001. Conversation text window 1001 may include a welcome message 1002 from the agent. Welcome message 1002 may include a question presented to the user based on information captured while the user accessed the website or a predefined question stored, for example, in database 110 or database 120. For example, the welcome message may ask a user why the user is interested in a particular type of product. The user then enters a response 1004 to welcome message 1002 in user interface 900. An agent follow-up response 1006 may include information related to response 1004. For example, agent follow-up response 1006 may include a product hyperlink 1008 to a product selected by the agent based on response 1004 and/or the information captured while the user accessed the website. Additionally, or in the alternative, agent follow-up response 1006 may include a hyperlink 1010 to social network application 310 based on response 1004 and/or the information captured while the user accessed the website. Selection of hyperlink 1010 may take the user directly to a recommended discussion hosted by social network application 310 in a read-only mode or may take the user to a registration and/or login page of the social network hosted by social network application 310.

The agent scans responses of the user(s) for keywords and phrases using a natural language search engine to populate suggestions and answers and to return relevant information to the user. Thus, the agent attempts to gain enough information to make an intelligent product or discussion recommendation. For example, if a product match is found, the agent may respond with “Here is a product X from company Y you might like”. If no product match is found, the agent may suggest that the user select “Enter Network” button 906 or hyperlink 1010 to look for more information. A user tag cloud may be generated from both the responses of the user and the keywords identified during the user's interaction with web server application 306 and/or conversation facilitator application 308. Recommendations may be presented to the user in the form of a hyperlink. In an exemplary embodiment, the tag cloud generation and product/discussion suggestion process is implemented as follows:

When a user accepts an electronic conversation, the session keywords and any conversation elements may be incorporated into a root word list which is “weighted” based on the number of times the root word is used in the conversation. For example, a user tag cloud between two users talking about Caribbean vacations might include: Caribbean—5; travel—6; virgin—2; island—5; ship—1; etc. The text of the conversation may be evaluated as a word stream. A list of “stop words, such as common words like “the”, “my”, “and”, etc. may not be considered useful to the tag cloud and, as a result, may not be included in the tag cloud. The remaining words may be reduced to their root form to identify similar words in their most common form. For example, travel, traveling, and traveled may all be reduced to ‘travel’.

In the social network associated with the website, discussions may have an associated tag cloud which is generated as the user's post comments to a discussion between users of social network application 310. In addition, a product list may be provided initially for recommendation to users during a conversation based on the website associated with the social network. The product list may include a product description and keywords defined for each product. The product list also may be included in a product tag cloud. During an electronic conversation, a comparison of the user tag cloud to the discussion tag cloud and/or product tag cloud is performed. In an exemplary embodiment, matching keywords are identified and a match value is calculated by adding the weights of matching root words. A product or discussion with the highest match value may be considered a best match. A threshold can be defined and associated with a product match and/or a discussion match. The threshold controls can be defined to make it easier or harder to identify a product or discussion for suggestion during the electronic conversation. For example, if the product threshold is set at “10” and the discussion threshold is set at 100, it is more likely that a product is recommended than a social network discussion during an electronic conversation.

Thus, as the user interacts with electronic conversation application 212, a response is received from the user at user device 104a and ultimately by conversation facilitator application 308. A determination may be made concerning whether or not a keyword is identified in the received response. Identified keywords are added to the user tag cloud associated with the electronic conversation that also may include interaction indicators identified during the user's interaction with the website. A suggestion may be inserted into the electronic conversation based on a comparison with the highest match value between the user tag cloud and a tag cloud associated with one or more suggestions and a match threshold value associated with the one or more suggestions. If the highest match value satisfies a comparison with the match threshold value the suggestion may be sent to the user devices participating in the electronic conversation as a suggestion by the agent.

Additionally, if a keyword is identified, a search may be executed by conversation facilitator application 308 using the identified keyword. For example a search of the website may be executed. Alternatively or additionally, a search using a search engine such as the Google™ search engine may be executed. A determination of whether or not a matching search result was identified from the executed search is made. If a matching search result is identified the matching search result is sent to the user at user device 104a and presented to the user. For example a link to a web page having information related to the topic of interest to the user is sent to user device 104a for presentation using browser application 210 or electronic conversation application 212. As the conversation is conducted with the agent the user profile is updated and stored for example in database 110 or database 120.

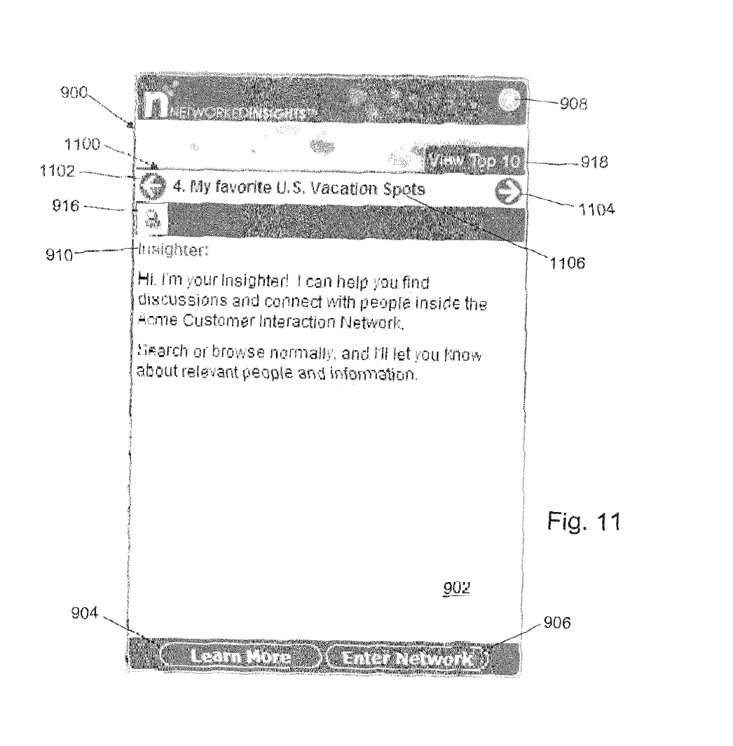

After user selection of “View Top 10” button 918 user interface 900, shown with reference to FIG. 11 may be presented to the user in display 200 under control of conversation facilitator application 308. In the exemplary embodiment of FIG. 11 user interface 900 includes a ticker-style display 1100. Ticker-style display 1100 may include a previous scroll button 1102, a next scroll button 1104, and a hyperlink 1106 to a selected one of the top ten currently most active discussions in social network application 310. User selection of hyperlink 1106 prompts conversation facilitator application 308 to present a login screen to social network application 310 or an initial screen for the discussion associated with the selected hyperlink 1106. A variety of different types of hyperlinks may be presented in ticker-style display 1100. A variety of mechanisms may be used to present the display of the information as known to those skilled in the art.

In operation 448, a determination is made concerning whether or not other users are using the website. If no other users are using the website, the electronic conversation is continued at operation 446. If other users are using the website, processing continues at an operation 450. In operation 450, a determination is made concerning whether or not to offer participation in a multi-user conversation is to be made to the user. In an exemplary embodiment, the criteria may include a length of time spent on the website and/or keywords. For example, after the user's initial interaction with the website is detected through receipt of the user interaction indicator, a timer may be started. After a predefined time period, a determination may be made to make an offer to the user to participate in a multi-user conversation. An example time period is two minutes though any time period may be used. If no offer is to be made, the electronic conversation is continued at operation 446.

In operation 452, the user profile(s) of the other user(s) are compared with the user profile of the user at user device 104a. The comparison between the user profiles identifies users having similar interests and needs, for example, based on common keywords identified between the user profiles. The “match level” defined before multiple users are considered to have similar interests and can be invited to the same conversation may include multiple levels of keywords. As an example, a set of users on a site may be tagged as follows:
User1->Art
User2->Art:Glass:Bowls
User3->Art:Glass:Ornaments
User4->Furniture:Wood:Chairs:Rockers
User5->Furniture:Wood:Chairs:Barstools

Based on the match-level threshold specified, the users may be ‘matched’ as follows:
Match Level=1 User1, User2, User3 invited to join Conversation A and User4, User5 invited to join Conversation B
Match Level=2 User2, User3 invited to join Conversation A and User4, User5 invited to join Conversation B
Match Level=3 User4, User5 invited to join Conversation A
Match Level=4 or 5 None of the users are invited to join a conversation.

In operation 453, a determination is made concerning whether or not to offer participation in a multi-user conversation to the user. In an exemplary embodiment, a match level of two is used to initiate a multi-user electronic conversations. If the offer of the conversation with the one or more other users is to be offered, processing continues at an operation 454. If the offer of the conversation with the one or more other users is not to be offered, the electronic conversation is continued at operation 446. In operation 454, a request is sent to the user to join the conversation with the one or more other users and the agent. An invitation and an introduction is made through the agent that translates information from the user profile and the user profile comparison into a welcoming statement to entice the user into the electronic conversation. In an operation 456, a response is received from the user at the user device 104a. In an operation 458, a determination of whether or not to initiate the conversation with the one or more other users and the agent is made based on the received response. If the offer of the conversation with the one or more other users and the agent is accepted, processing continues at an operation 460. If the offer of the conversation with the one or more other users and the agent is not accepted, the electronic conversation is continued at operation 446. In operation 460, the conversation is initiated with the user at user device 104a and continues until one or more of the users choose to exit the conversation. If users leave a multi-user conversation, the agent may attempt to engage the last remaining user in a single-user conversation using information from the previous conversation to make a product and/or discussion suggestion.

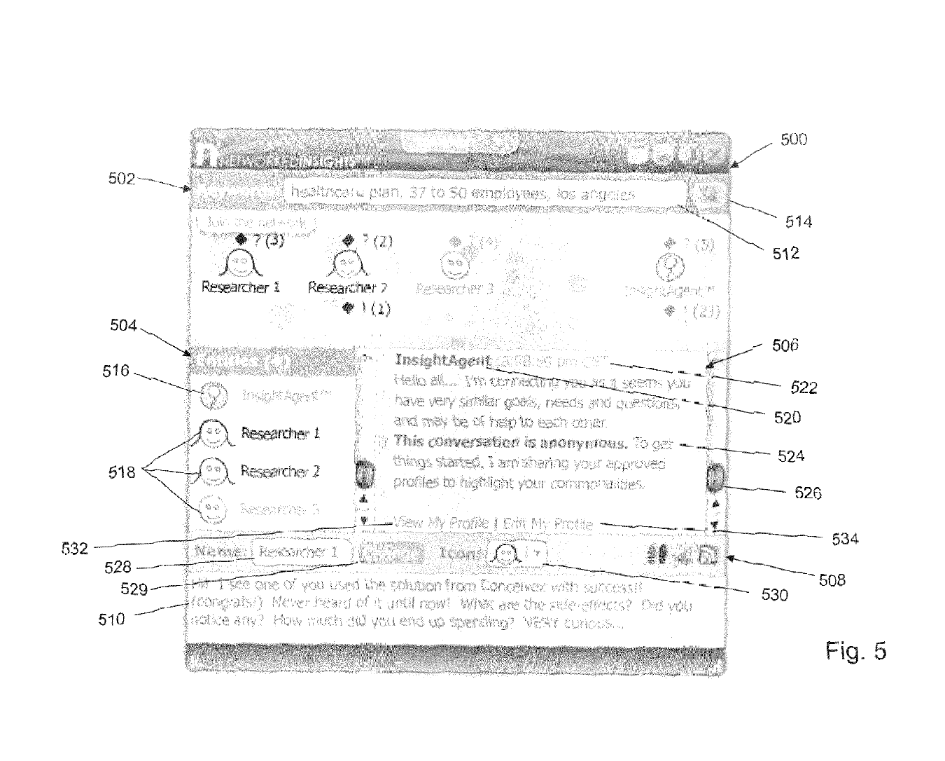

In an exemplary embodiment, the one or more other users may already be participating in an electronic conversation and the user at user device 104a joins the conversation. The conversation may be presented using browser application 210 or electronic conversation application 212. For example, with reference to FIG. 5, a user interface 500 of an electronic conversation system is shown in accordance with an exemplary embodiment. User interface 500 may include a search query section 502, an entity list 504, a conversation tracker 506, a user customization section 508, and a conversation text entry field 510. Search query section 502 provides interface elements that allow the user at user device 104a to conduct a search using terms and search criteria entered in search text box 512 upon selection of search execution button 514. Entity list 504 includes a list of the users that have been matched to each other and are currently participating in the electronic conversation. The list of the users includes agent 516 and one or more users 518. Conversation tracker 506 includes a user identifier 520, a time 522, a user statement 524, and a conversation scroll bar 526. User identifier 520, time 522, and user statement 524 are associated with each statement made by a user participating in the conversation. Conversation scroll bar 526 allows the user at user device 104a to review the entire conversation.

User customization section 508 may include a user name text box 528, a user name change button 529, a user icon selector 530, a profile viewer button 532, and a profile editor button 534. User name text box 528 displays a name of the user at user device 104a. The name is associated with the user and is displayed for the user in entity list 504 and for the user in user identifier 520. The user can edit their name by selecting user name change button 529. Selection of user name change button 529 causes a text box to be presented to the user. The user can enter a desired name in the text box. Selection of user icon selector 530 allows a user to select an icon included in entity list 504 to represent the user. For example, the user may select from an icon indicating that the user is female or is male. Selection of profile viewer button 532 allows the user to view their user profile. Selection of profile editor button 534 allows the user to edit their user profile. The user participates in the conversation by entering statements in conversation text entry field 510.

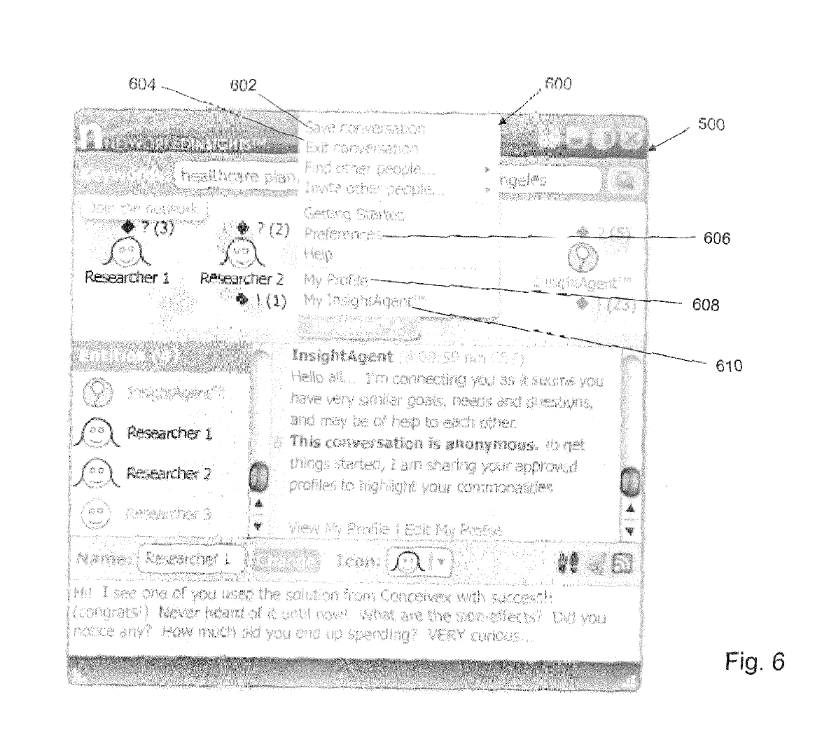

With reference to FIG. 6, a menu 600 of the user interface of FIG. 5 is shown in accordance with an exemplary embodiment. Menu 600 may include a conversation save item 602, a conversation exit item 604, a preferences edit item 606, a profile edit item 608, and a agent edit item 610. The items included in menu 600 may differ based on whether or not the user has joined the social network or not. Selection of conversation save item 602 saves the conversation, for example, to database 110 and/or database 120. The saved conversation may be associated with one or more of the user, the website, the conversation, etc. Selection of conversation exit item 604 ends the user's participation in the conversation which may continue with any remaining users. Selection of preferences edit item 606 presents options from which a user may select preferences associated with use of menu 600. Selection of profile edit item 608 presents the user profile to the user for editing. Selection of agent edit item 606 presents options to the user related to the agent.

In editing the user profile, a user may have the option to select one or more anonymity level. In an exemplary embodiment, the user may select sub-networks/groups of the social network in which the user's profile may be shared. Additionally, or in the alternative, the user may select each item of the user profile which may be shared. In this way, the user has control of the data captured during interactions with the website and/or social network. The user may select the anonymity levels by selecting preferences edit item 606, profile edit item 608, and/or agent edit item 606.

The agent listens to the conversation and inserts statements as appropriate based on the conversation. For example, a tag cloud is created which represents what the users are discussing. The tag cloud also may include the keywords used to identify the users and to initiate the invitation to enter the conversation. The tag cloud may be periodically compared to a listing of products that may be associated with the website, and/or to the content of discussions within a social network associated with the website. When a match is identified, the agent suggests the product to the conversation participants. Product links may take the user directly to the product page. Discussion links may cause presentation of a login page of social network application 310 or of present a welcome page to social network application 310. The frequency of interjections by the agent in the multi-user conversation may be dynamic and configurable. For example, if the users are actively conversing the agent may only interject with suggestions every ‘X’ number of conversation exchanges between the conversation participants. If the users stop actively conversing, but do not actually exit electronic conversation application 212, the agent may interject suggestions every ‘Y’ number of seconds. The timer resets each time a user makes a conversation entry.

An exemplar conversation may include the following series of statements:
Agent: Hi, I asked you all here because you have similar needs and interests. Hopefully, you can be of some help to each other. Remember this conversation is anonymous, and the only thing you know about each other is your common reason for visiting MyHealth.com.
User 2: Hi
User 1: my husband and I have been struggling to have our first child so we have opted for fertility treatment—do you know how much it costs?
User 2: Me too, we have one child and are trying for our second
User 3: Hi We decided after trying to get pregnant that we would look into adoption, we might still go down the path of fertility treatment but we will see.
User 2: My doctor told me the initial visits cost about $2,000 but the total is around $10,000
User 1. WOW! Are there any other options before going to the fertility treatment?
Agent: Here is some useful information on the costs of fertility http://www.myhealth.com/fertility-pages/fee.html
User 3. We tried a new product with our first child—we tried to get pregnant and struggled and our friend recommended this company called Conceivex, they have a solution that basically allows you to place the semen right next to the cervix. It worked for us and we had been struggling for 2 years.
Agent: Information on Conceivex can be found at http://www.conceptionkit.com
User 2. I have not heard of that I should check it out
User 3. Do either of you know of any good sources that talk about adoption and health coverage
Agent: adoption and health coverage information can be found through our partner at http://www.nefe.org/adoption/adopt.pgs/expc.html
Agent: MyHealth has a social network of people that are discussing fertility and other topics related to Infertility if you would like to join please click Join below and start interacting with a wider community with more information.

In parallel with the operations described with reference to operations 436-460, or separate from the operations described with reference to operations 436-460, the operations described with reference to FIG. 4c may be executed. In an operation 406, the user profile is compared with criteria for inviting the user to join a social network/sub-network/group. Use of the term social network includes any subs networks and/or groups and is not intended to be limited to merely social interactions. For example, the interactions could be work related. In an operation 408, a determination of whether or not to offer membership in the social network is made based on the comparison with the criteria. For example, membership may be based on an evaluation of one or more user profile attributes. If the offer of membership in the social network is to be offered, processing continues at an operation 410. If the offer of membership in the social network is not to be offered, processing continues at operation 430.

In operation 410, an offer to join the social network is sent to the user at user device 104a. For example, the offer is presented to the user of user device 104a in a user interface of browser application 210. In an operation 412, a response is received from the user at user device 104a. For example, user selection of a “Yes” button or of a “No” button may be received. In an operation 414, a determination of whether or not to add the user to the social network is made based on the received response. If the offer of membership in the social network is accepted, processing continues at an operation 416. If the offer of membership in the social network is not accepted, processing continues at operation 430. In operation 416, the user is added to the social network. For example, a user name and a password may be requested from the user. Additionally, a request may be sent to the user at user device 104a to enter or to modify data entered in the user profile. Attributes of the user profile may be automatically entered, but can be modified by the user. Both entries may be saved together or separately. Before presenting the user profile to the user, the user may be asked how long they want to spend in completing their user profile. If no attributes of the user profile are received from the user at user device 104a, a prompt may be sent to the user to enter required attributes of the user profile. In an operation 418, the user profile is updated and saved.

A plurality of user profiles may be maintained for each user of the social network. For example, a company profile, which generally already exists, may be defined based on user membership in an organization. For example, a user company profile may be defined for a user that is a member of a health care organization. A second user profile may be developed through user interaction with the website electronic conversations with the agent or other users, etc. The user profile data elements may be populated automatically as they are identified by the agent based on interactions with the users at various points in time. Additionally, the agent may ask a series of questions about the user during these interactions. The user's answers may be used to populate both user profiles.

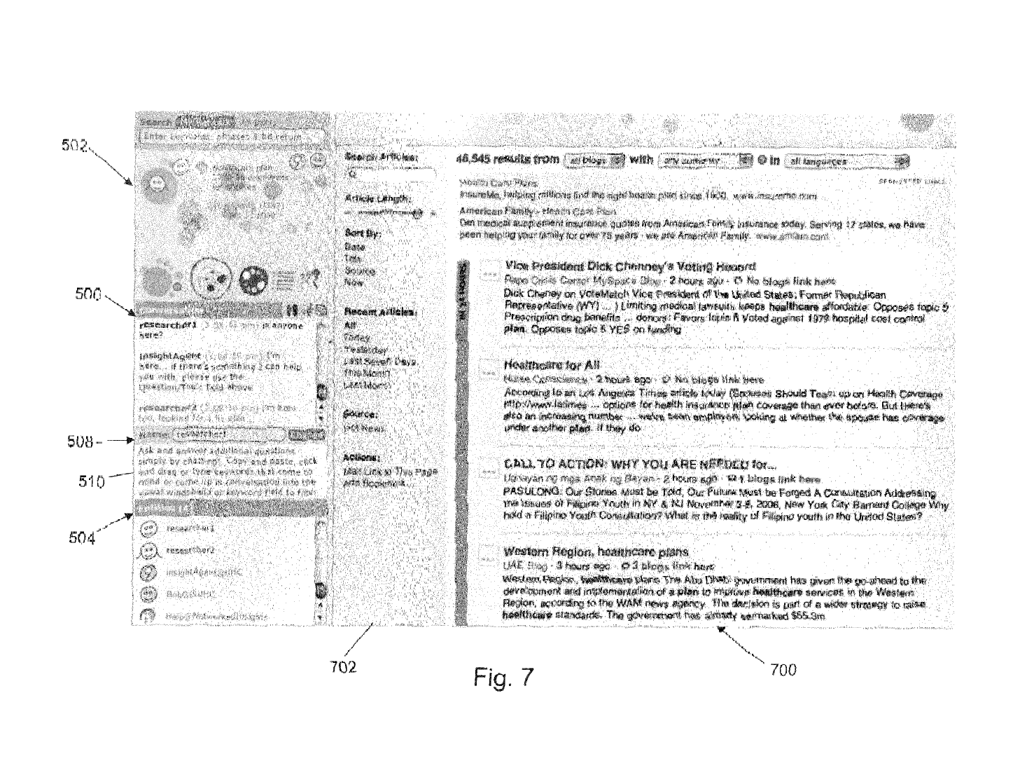

In an operation 420, the user at user device 104a is provided with a user interface to social network application 310. In an exemplary embodiment. User 1 and User 2 decide to join the social network and are directed to a group already discussing fertility through blogs, postings, and other information accessible using social network application 310. With reference to FIG. 7, a user interface 700 of social network application 310 is shown in accordance with an exemplary embodiment. Social network application 310 provides a complete social networking solution in which users can interact with other users, share content, view their community, etc. These interactions may be driven by search, by profile matching, by keywords, by conversation contributions, etc. User interface 700 may include a series of dynamic viewers that update with a depiction of others that are in the social network to allow users to identify other users of interest. For example, if a user is searching on “World War II” within the social network, user interface 700 may show the groups, individuals, and content rooms closest to the user that have direct relevance to the search topic. Individuals, groups, and content rooms interested in “World War I” may also be shown, but at a greater distance from the user and with less emphasis. Groups, individuals, and content rooms interested in “World War II” and having the closest match based on user profile attributes may be emphasized in user interface 700.

User interface 700 may be presented in browser application 210 and/or electronic conversation application 212 at user device 104a. For example, user interface 700 may be accessed by the user using browser application 210 and a URL associated with the website. User interface 700 may include search query section 502 entity list 504, conversation tracker 506, user customization section 508, conversation text entry field 510, and an information presentation section 702. The agent also participates in the social network. The agent listens to the conversation and inserts statements as appropriate based on the conversation. Information presentation section 702 provides additional information to the user such as a blog related to a topic of interest to the user. User interface 700 additionally may include a user profile manager, a session record capability, an invite others capability, an internal search capability, and an external search capability.

Through use of conversation facilitator application 308 and social network application 310, interactions with and between users can be monitored throughout an entire product adoption process. A product adoption process may include 1) identifying a need, 2) investigating solutions to the identified need, 3) evaluating the solution options, 4) selecting a solution from the solution options, 5) integrating/implementing the selected solution, 6) using the integrated solution, 7) measuring the performance of the solution, and 8) referring other to the solution. Users identify their needs by visiting a website to look for solutions. Conversation facilitator application 308 and social network application 310 support interactions that help users identify solutions to their needs through interactions with others and/or through interactions with the agent.

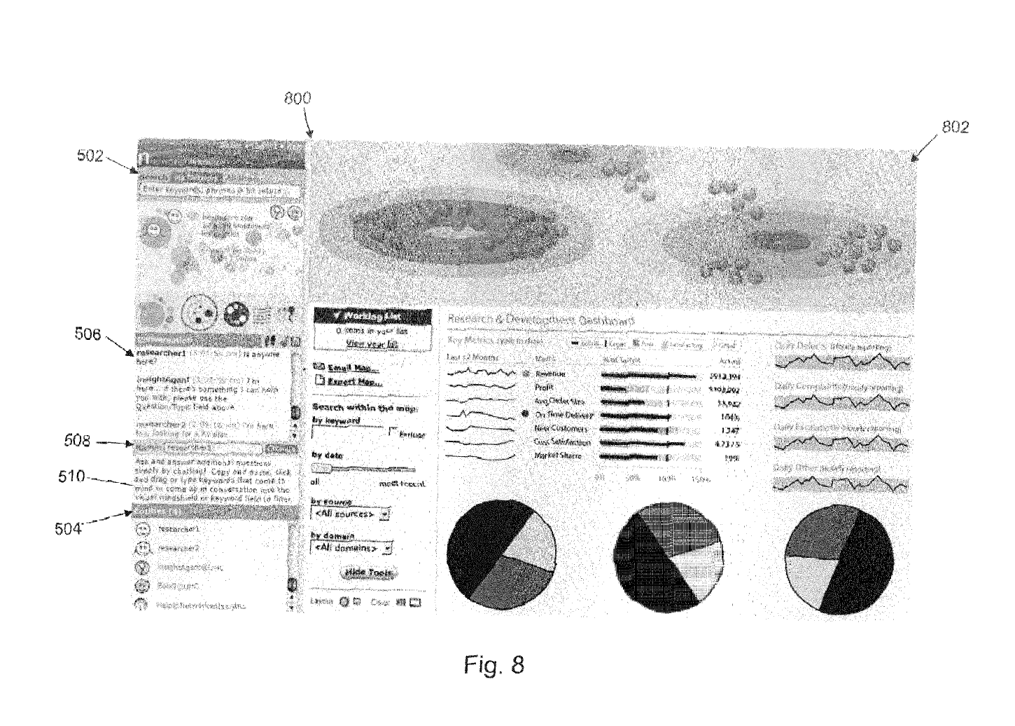

With reference to FIG. 8, a user interface 800 of interaction processing/reporting application 312 is shown in accordance with an exemplary embodiment. Interaction processing/reporting application 312 provides a visual representation of the data elements captured during interactions. These data elements may be personalized using an electronic job description of an employee who is the user of interaction processing/reporting application 312. Additionally, an annual review itemizing areas in which the employee is working and a personal interests description based on searches and interactions the employee has during their tenure with the company may allow personalization of the data elements. If the user is not an employee, the data may be personalized using the user profile. Characteristics of user interface 800 of interaction processing/reporting application 312 may differ for users that are employees as compared to users that are not employees. The same or different users may access one or more of conversation facilitator application 308, of social network application 310, and of interaction processing/reporting application 312.

User interface 800 may be presented in browser application 210 at user device 104a. User interface 800 may include search query section 502, entity list 504, conversation tracker 506, user customization section 508, conversation text entry field 510, and a network information presentation section 802. Network information presentation section 802 allows a user to visualize what is happening in the network using data mining tools, a natural language search engine, and personalized data analyzers. The data presented in user interface 800 may be updated as the information in the user profiles is received. For example, a user works in MyHealth's marketing group and uses interaction processing/reporting application 312 to access daily reports associated with their area of responsibility. Thus, the user of interaction processing/reporting application 312 may be an employee of the company associated with the website or a user obtaining information from or associated with the website. The user of interaction processing/reporting application 312 obtains reports based on interactions with the website, with the agent, with the other users of the website, and/or with the social network. Preparation of the reports may include use of data filters, use of viewers, and use of data mining tools that are driven by keywords and nontrivial events that happen within the social network. An adoption process indicator associates each user interaction indicator with an indicator that determines its phase in the adoption process to determine the amount and types of resources a user may invest in a particular stage in the process.

In an exemplary embodiment, interaction processing/reporting application 312 may include a filtering tool that allows users to mine the most discussed/searched topics in the social network and communities within the social network. For example, the most discussed topics may be determined based on a frequency of additions and/or a frequency of hits. The most discussed topics may be filtered by segment, by demographic group, by community, by social network, by location, etc. The segment may be defined by a company segmentation schema and data structure through integration of the company's data structure with the user profile. The demographic group may be defined based on the user profile. As another example, a least discussed, but most frequently visited topic may be determined.

In an exemplary embodiment, interaction processing/reporting application 312 may include a search tool that can perform searches based on a keyword, related phrases, a product, a segment, a purchase, a transaction, a fad topic, etc. For example, a time that a fad topic remains of interest may be determined using the search took. The search functionality may be provided to a user of user interface 800 of interaction processing/reporting application 312, to a user of user interface 700 of social network application 310, and/or to a user of user interface 500 of the electronic conversation system.

In an exemplary embodiment, interaction processing/reporting application 312 may include an extended network analyzer tool to understand the influencers, advisors, and relationships that members of the social network have. These can include other social networks, companies, non-profits, blogs, etc. A cookie may be created to track the entry and exit points of each member of the social network. The entry and exit point information may be categorized and sorted by community, by segment, and/or by topic. Using this information, relevant websites may be identified. The identified relevant sites may be searched automatically. Additionally or in the alternative, the extended network analyzer tool may search the social network for websites identified by users in their profiles, in their personal pages, in their scrapbooks/file cabinets, and in their communities.

In an exemplary embodiment, interaction processing/reporting application 312 may include a community demographics characterization tool to understand the similarities of members of communities within the social network. The community demographics characterization tool helps understand potential new segments, segments belonging to communities, needs of community members, the adoption process stage, etc. For each community, a summary profile may be created to summarize the profiles in the community. The various types of profile data are translated into the various stages of the adoption process. The stage in the adoption process may be determined by an evaluation of a purchasing history, of a number of interactions with customer service, of a total number of interactions with the company (online and offline), of interactions associated with a topic, of a number of trusted advisor interactions, of trusted advisor classifications present in the community, etc.

In an exemplary embodiment, interaction processing/reporting application 312 may include a segmentation tool to identify how segments evolve in a community so that new and emerging needs can be identified; new product/service opportunities can be uncovered; current products not meeting user needs can be identified, etc. User profiles may be linked to a current segment of the company associated with the user. Segmentation may also be based on the community; on community needs, on a segment value proposition based on what the community values, on a segment based on an unmet community need, on the adoption cycle, etc.

In an exemplary embodiment, interaction processing/reporting application 312 may include a marketing tool that creates strategic marketing insights and that supports tactical marketing decisions. The marketing tool may provide search engine optimization analysis based on the most searched topics of the community and/or the most relevant topics and types of communication users want. Transaction data may be linked to the most frequently used and searched topics.

In an exemplary embodiment, interaction processing/reporting application 312 may include a questionnaire/survey tool to poll the social network. Polling may be conducted by a user of user interface 800 of interaction processing/reporting application 312 and/or by a user of user interface 700 of social network application 310. Permission may be obtained from the communities and/or individuals to use the questionnaire/survey tool. Limits may be set by the creator of the community relative to the complexity of the questionnaire or survey such as the number of questions, the number of multiple choice versus free form answers, etc., relative to who can create a questionnaire, relative to a frequency of surveys, etc. In an exemplary embodiment, interaction processing/reporting application 312 may include an evaluation tool that allows reports to be generated from the survey answers. Survey answers may be grouped by characteristics of users, communities, and segments.

In an exemplary embodiment, interaction processing/reporting application 312 may include a panel tool that supports a continuous active interaction between a company and customers. For example, an employee of the company may invite social network members to a panel event.

In an exemplary embodiment, interaction processing/reporting application 312 may include a marketing understanding tool to help companies understand what mechanisms to use in communicating with customers, who customers consider trusted sources, when to communicate with customers, how often to communicate with customers, and/or how to protect communication information. The marketing understanding tool mines conversations to understand the types of conversations customers want to have. The types of conversations may range from burst (short snippets of information) to in-depth (large pieces of information that provide all relevant info). Marketing statistics data may be used in combination with data from the social network to understand the frequency of communication that segments or members want.

In an exemplary embodiment, interaction processing/reporting application 312 may include a competitive analysis tool to provide a customer perspective of the competition. The competitive analysis tool may include a graphical display showing the valuation of the competition based on conversations within the network and by specific segments. The competitive analysis tool may include a competitive profile developed based on feedback from the social network. The competitive analysis tool may include a bulletin created when a competitor or a competitor's product/service has a high level of interest or discussion within the social network. The competitive analysis tool may include a competitive product/service value evaluation based on complaints about the competitive product/service. The competitive analysis tool may provide an evaluation of competition by segment. The competitive analysis tool may include a favorite solution for a problem.

In an exemplary embodiment, interaction processing/reporting application 312 may include a product/service discussion tool to provide insight into the current use, problems with, positive attributes of, support for, and new opportunities for products and services. The product/service discussion tool may evaluate product use for a segment, a community, or a smaller grouping by combining company purchase data, customer company product/service interactions, and the product/service discussion data in the community. The product/service discussion tool may evaluate how well needs are being met by products/services using the most discussed topics by segment/community. Additionally, the user interaction data may be searched automatically for the company's product names and the competitor's product names.

In an exemplary embodiment, interaction processing/reporting application 312 may include a loyalty identification tool to determine where a customer fits on the loyalty spectrum based on their willingness to solve their needs with solutions provided by the company. When a user is tagged as having reached the advocacy stage in the adoption process, the user is identified and the company is made aware of their loyalty value. A lifetime value of a customer can be determined based on their interactions and how loyal they are.

In an exemplary embodiment, interaction processing/reporting application 312 may include a marketing automation tool to create marketing collateral that can be delivered to the network. The marketing automation tool may identify a list of constituents for which the marketing collateral is relevant. The marketing automation tool may measure the success of a marketing campaign, for example, based on a discussion rate, a discussion longevity, and a time from mailing to generation of a discussion related to the campaign.

In an exemplary embodiment, interaction processing/reporting application 312 may include a relationship and data visualization tool to provide a variety of views of different segments of the social network. The different views may be determined based on data contained within a user profile.

In an exemplary embodiment, interaction processing/reporting application 312 may include a sales and business development tool to provide new types of data to both sales and business development. The new types of data may be linked to a group of customers or a specific customer and may detail the topics/areas of concern for a specific customer to identify customer needs, product usage, emerging needs, competitive perception, customer strategies, etc. A high level report for business development may identify other companies being discussed in the social network and the context in which they are relevant.

The word “exemplary” is used herein to mean serving as an example instance, or illustration. Any aspect or design described herein as “exemplary” is not necessarily to be construed as preferred or advantageous over other aspects or designs. Further, for the purposes of this disclosure and unless otherwise specified, “a” or “an” means “one or more”. The exemplary embodiments may be implemented as a method, apparatus, or article of manufacture using standard programming and/or engineering techniques to produce software, firmware, hardware, or any combination thereof to control a computer to implement the disclosed embodiments.

The foregoing description of exemplary embodiments of the invention has been presented for purposes of illustration and of description. It is not intended to be exhaustive or to limit the invention to the precise form disclosed, and modifications and variations are possible in light of the above teachings or may be acquired from practice of the invention. The functionality described may be implemented in a single executable or application or may be distributed among modules that differ in number and distribution of functionality from those described herein. Additionally, the order of execution of the functions may be changed. The embodiments were chosen and described in order to explain the principles of the invention and as practical applications of the invention to enable one skilled in the art to utilize the invention in various embodiments and with various modifications as suited to the particular use contemplated.

What is claimed is:

1. A device for automatically identifying users for an electronic conversation, the system comprising:
a processor;
a communication interface operably coupled to the processor, the communication interface configured to receive a user interaction indicator from a computer system using a network; and
a computer-readable medium operably coupled to the processor, the computer-readable medium configured to store the received user interaction indicator, the computer-readable medium comprising instructions that, upon execution by the processor, perform operations comprising
receiving the user interaction indicator from the communication interface, the user interaction indicator indicating an interaction by a user at the computer system with a website;
determining whether to initiate an electronic conversation with the user at the computer system based on predefined criteria and the received user interaction indicator; and
if a determination to initiate the electronic conversation is made, initiating the electronic conversation with the user at the first computer system.

2. A computer-readable medium comprising computer-readable instructions therein that, upon execution by a processor, cause the processor to automatically identify users for an electronic conversation, the instructions configured to cause a computing device to:
receive the user interaction indicator from the communication interface, the user interaction indicator indicating an interaction by a user at the computer system with a website;
determine whether to initiate an electronic conversation with the user at the computer system based on predefined criteria and the received user interaction indicator; and
if a determination to initiate the electronic conversation is made, initiate the electronic conversation with the user at the first computer system.

3. A method for automatically identifying users for an electronic conversation, the method comprising:
receiving a user interaction indicator at a first computer system from a second computer system, the user interaction indicator indicating an interaction by a user at the second computer system with a website;
automatically determining whether to initiate an electronic conversation with the user at the second computer system based on predefined criteria and the received user interaction indicator; and
if a determination to initiate the electronic conversation is made, initiating the electronic conversation with the user at the second computer system.

4. The method of claim 3, wherein the electronic conversation is initiated with an agent, wherein the agent is a computer generated entity.

5. The method of claim 4, further comprising storing the received user interaction indicator in a user profile accessible by the first computer system.

6. The method of claim 5, further comprising receiving a second user interaction indicator at the first computer system from the second computer system and identifying a keyword associated with the received second user interaction indicator.

7. The method of claim 6, further comprising identifying a suggestion for the user based on the identified keyword and sending the identified suggestion to the user at the second computer system, the identified suggestion associated with the agent.

8. The method of claim 7, wherein the identified suggestion includes a hyperlink to a webpage.

9. The method of claim 8, wherein the hyperlink is associated with a social network.

10. The method of claim 4, wherein initiating the conversation comprises:
sending a request to join the conversation to the user at the second computer system,
receiving a response from user at the second computer system; and
if the received response indicates acceptance of the request, sending a question to the user at the second computer system.

11. The method of claim 3, wherein the electronic conversation is conducted using at least one of a text messaging application, an instant messaging application, a chat session application, an e-mail application, a short messaging service application, and a multimedia messaging service application.

12. The method of claim 3, wherein the user interaction indicator is at least one of a search term entered at the website by the user, a data entry item entered at the website by the user, a click stream generated at the website by the user, an entry point to the website, a time since the user accessed the website, an Internet service provider used to access the website, a login name entered by the user, an exit point from the website, and a cookie associated with the website.

13. The method of claim 3, wherein the predefined criteria includes a time value and the determination is based on a time since the user accessed the website.

14. The method of claim 3, wherein the electronic conversation is initiated with a second user interacting with the website.

15. The method of claim 14, wherein the electronic conversation further is initiated with an agent, wherein the agent is a computer generated entity.

16. The method of claim 14, wherein determining whether to initiate the electronic conversation with the user at the second computer system comprises:
receiving a second user interaction indicator at the first computer system from a third computer system, the second user interaction indicator indicating an interaction by a second user at the third computer system with the website;
comparing the received user interaction with the received second user interaction, and
determining whether to initiate the electronic conversation between the user and the second user based on the comparison.

17. The method of claim 16, wherein comparing the received user interaction with the received second user interaction comprises:
identifying a first keyword associated with the received user interaction indicator;
identifying a second keyword associated with the received second user interaction indicator; and
comparing the identified first keyword with the identified second keyword to determine a match lever.

18. The method of claim 17, wherein determining whether to initiate the electronic conversation between the user and the second user based on the comparison comprises determining if the determined match level satisfies a threshold test.

19. The method of claim 16, wherein the electronic conversation further is initiated with an agent, wherein the agent is a computer generated entity, the method further comprising:
identifying a suggestion for the electronic conversation between the user at the second computer system and the second user at the third computer system based on the identified first keyword; and
sending the identified suggestion to the user at the second computer system and to the second user at the third computer system, the identified suggestion associated with the agent.

20. The method of claim 19, wherein identifying the suggestion comprises:
identifying a plurality of keywords associated with a plurality of user interactions received from the user at the second computer system and the second user at the third computer system;
comparing the identified plurality of keywords with a suggestion keyword associated with the suggestion;
determining a match value based on the comparison; and
if the match value satisfies a match threshold value associated with the suggestion, identifying the suggestion.

21. The method of claim 19, wherein the identified suggestion is sent based on a number of exchanges between the user at the second computer system and the second user at the third computer system.

22. The method of claim 3, wherein the electronic conversation is initiated with a social network.
